(19) United States
(12) Patent Application Publication
(10) Pub. No.: US 2006/0021933 A1
(43) Pub. Date: Feb. 2, 2006

(54) Ring filter

(75) Inventor: Scott Radcliffe, Berkley, MI (US)

Correspondence Address: VOLPE AND KOENIG, P.C., UNITED PLAZA, SUITE 1600, 30 SOUTH 17TH STREET, PHILADELPHIA, PA, 19103, US

(73) Assignee: INA-Schaeffler KG, Herzogenaurach (DE)

(21) Appl. No.: 11/193,179

(22) Filed: Jul. 29, 2005

Related U.S. Application Data
(60) Provisional application No. 60/592,227, filed on Jul. 29, 2004.

(51) Int. Cl. B01D 35/02

(52) U.S. Cl. 210/483; 210/459; 210/497.01

(57) ABSTRACT

A ring filter (1) for filtration of hydraulic fluid has a filter section (2) and frame elements (3). The filter section (2) includes a filter screen (6) and a second segment (5) that is impermeable to hydraulic fluid. Both the frame elements (3) and also the second segment (5) are formed of an expandable material.

### FIELD OF THE INVENTION

The invention relates to a ring filter for filtration of hydraulic fluid, with a filter section that is formed essentially in the shape of a cylindrical surface.

### BACKGROUND

Filters for filtering hydraulic and lubricating fluid are known. These known filters protect sensitive machine components connected in a hydraulic or lubricating fluid circuit from the introduction of contaminating particles into the components with the hydraulic or lubricating fluid. Such components can be, for example, hydraulic play compensating elements, switchable cam followers of a valve drive of an internal-combustion engine, or hydraulic directional control valves, especially sliding valves. Such machine components comprise several elements, which can move relative to each other and which have a small distance from each other.

Hydraulic slide valves comprise, for example, an essentially hollow cylindrical valve housing with several connections. A control piston is arranged in this housing so that it can move in the axial direction. The connections are formed as openings in the valve housing, through which hydraulic fluid can flow into or out of the housing. The openings usually open into ring grooves, which are formed in the valve housing. The outer surface of the essentially cylindrical control piston is essentially fitted to the inner surface of the valve housing. Furthermore, the control piston is provided with several ring grooves, which are spaced apart from each other in the axial direction, whereby the connections of the directional control valve can be selectively connected to each other or separated from each other. If contaminating particles enter into the directional control valve, then there is the risk that these particles will reach the area between the control piston and the valve housing and thus lead to jamming of the directional control valve.

In DE 100 27 080 C2, such a 4/3 port directional valve (control valve) is shown for controlling a hydraulic camshaft adjuster. The hydraulic fluid connection, the working connections, and the tank connections are formed as ring grooves in the outer surface of the valve housing. In the bases of these grooves, openings are formed in the valve housing. In order to prevent the penetration of contaminants into the interior of the directional control valve, a ring filter is arranged within each ring groove. Each of the ring filters comprises a filter section and a frame, which surrounds the filter section. The filters essentially have a C-shaped cross section, wherein the two free ends of the filter point towards each other. The two free ends are provided with positive-fit means, by means of which the filter can be sealed after insertion into the ring groove.

A disadvantageous effect in this embodiment is the high expense during the assembly of the filter on the valve housing. The filter is inserted into the ring groove and then the positive-fit means must be brought into engagement within the ring groove.

If the filter is assembled incorrectly, there is the risk during the installation process of the control valve in the valve seat that the filter will become tilted between the control valve and the valve seat and become damaged or even sheared off.

Furthermore, the seal of the hydraulic fluid filter can fail due to improper assembly or due to forces generated during the operation of the internal-combustion engine. Consequently, contaminating particles can penetrate into the component to be protected by the filter, which leads to the above-noted problems.

### SUMMARY

Therefore, the invention is based on the object of avoiding these mentioned disadvantages and thus designing a ring filter, wherein the filter assembly is simplified, its processing reliability is increased, and the long-term functioning of the ring filter is guaranteed.

According to the invention, this objective is met in that the ring filter is circumferentially closed to itself and is provided so that it can expand reversibly. In a preferred embodiment, its inner dimensions are fitted to the outer dimensions of the groove base of the ring groove, in which the ring filter is to be inserted. For assembly, the ring filter is expanded in the peripheral direction, whereby its radius also increases. The ring filter can be moved over the component in the expanded state and positioned in the region of the ring groove. After reaching the desired position, the application of force, which caused the expansion of the ring filter, is stopped, whereby the ring filter reassumes its original shape. Here, the ring filter is embodied so that it contacts the groove base with a non-positive fit within the entire ring groove.

In a first embodiment of the invention, the filter section is embodied as a filter screen and is formed of an expandable material.

In this embodiment, the entire cylindrical surface of the filter section is expanded during the assembly process.

In an alternative embodiment of the invention, in the peripheral direction, the filter section comprises at least one first and one second segment, which are arranged alternately in the peripheral direction, with the second segment being impermeable to hydraulic fluid and being formed of an expandable material and with the first segment being formed of a non-expandable filter screen.

The filter screen can be formed of metal. In this case, a conventional, preferably planar, rectangular filter screen is used, with two opposite ends being bent around to face each other. The ends of the filter screen face each other with a certain spacing. This spacing is bridged by a second segment made from expandable material, which connects the ends of the filter screen to each other. This is advantageously realized such that the expandable material flows into the filter cloth when the filter section is being produced. The filter screen can be formed of metal or plastic. The second segment advantageously id formed of an elastomer.

During the assembly, the ring filter is expanded only in the regions formed of expandable material. The ring filter is guided over the machine component in the expanded state and positioned in the region of the groove. After stopping the application of force, which caused the ring filter to expand, the expandable segments, and thus the entire ring filter, assumes their original shape, whereby the ring filter comes into contact with the groove base of the ring groove.

It is also possible to form the filter section with several segments, which are impermeable to hydraulic fluid, which are formed of an expandable material, and which are arranged between non-expandable filter screen segments. By forming the filter section with several expandable regions, the ring filter can be further expanded in the peripheral direction before causing irreversible damage to the expandable segments.

Furthermore, a ring-shaped frame element, which is connected to the filter section along its entire periphery and which is formed of an expandable material, can be provided on each end of the filter section in the axial direction.

The ends of the cylindrical surface-shaped filter sections are each connected to a frame element, which likewise is formed of an expandable material. This can be realized, for example, such that during the production process of the ring filter, the elastomer flows over regions of the filter section and is held in these regions. Advantageously, the inner diameter of the frame elements is smaller than the inner diameter of the filter section and simultaneously, the outer diameter of the frame elements is greater than the outer diameter of the filter section.

In the assembled state of the ring filter, this ring filter sits with the two elastic frame elements on the groove base of the ring groove. The frame elements are designed such that a force directed inwards in the radial direction acts on the groove base. Therefore, it is guaranteed that the hydraulic fluid cannot flow between the frame elements and the groove base, and thus past the filter section. Furthermore, due to the differing inner and outer diameters of the filter section and the frame elements, a ring groove is formed between the groove base and the filter section, whereby the active filter surface is increased.

During the assembly, both the segments impermeable to hydraulic fluid and also the frame elements are expanded. Having reached the correct position, now both the segments which are impermeable to hydraulic fluid and also the frame elements cause a reduction of the ring filter in the peripheral direction, whereby this ring filter comes reliably into captive contact with the groove base of the ring groove.

Furthermore, the ring filter is arranged within a first ring groove of a control valve of a camshaft adjuster, with the first ring groove being formed in an outer surface of a valve housing of the control valve and being used as a connection for compressed fluid. Alternatively, the ring filter can be arranged within a ring groove of a hydraulic switching element of a switchable valve drive, with the ring groove being formed in the outer surface of the switching element of the valve drive and being used as a compressed-fluid connection.

### BRIEF DESCRIPTION OF THE DRAWINGS

Additional features of the invention emerge from the following description and from the drawings, in which an embodiment of the invention is illustrated in a simplified way. Shown are:

FIG. 1a is a perspective view of a ring filter according to the invention;

FIG. 1b is a side view of a ring filter according to the invention;

FIG. 1c is a longitudinal section view through a ring filter according to the invention along the line I-I from FIG. 1b;

FIG. 2 is a cross sectional view of a device for changing the control timing of an internal-combustion engine;

FIG. 3 is a longitudinal section view through the device for changing the control timing of an internal-combustion engine along the line III-III from FIG. 2, with a 4/3 port directional control valve;

FIG. 4 is a longitudinal section view through a 4/3 port directional control valve for controlling the device from FIGS. 2 and 3, with a ring filter according to the invention; and

FIG. 5 is a component of a valve drive with a ring filter according to the invention.

### DETAILED DESCRIPTION OF THE DRAWINGS

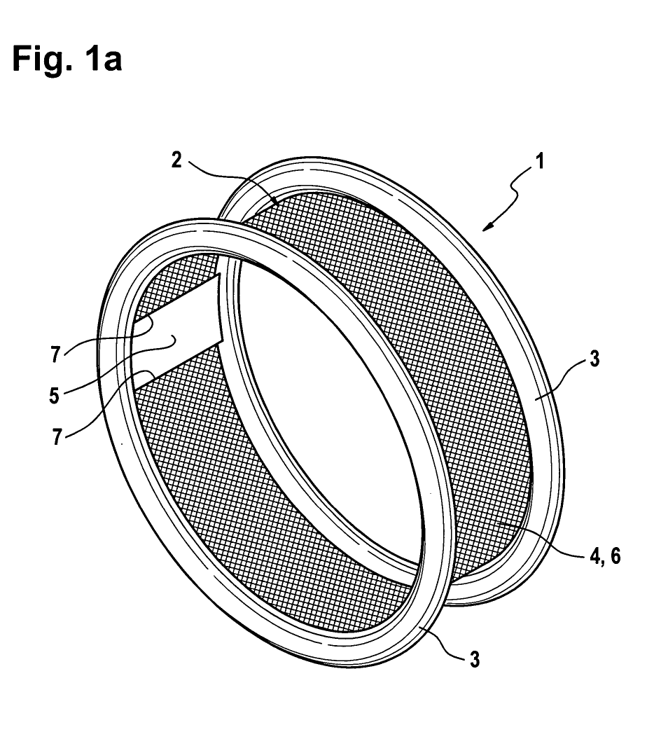

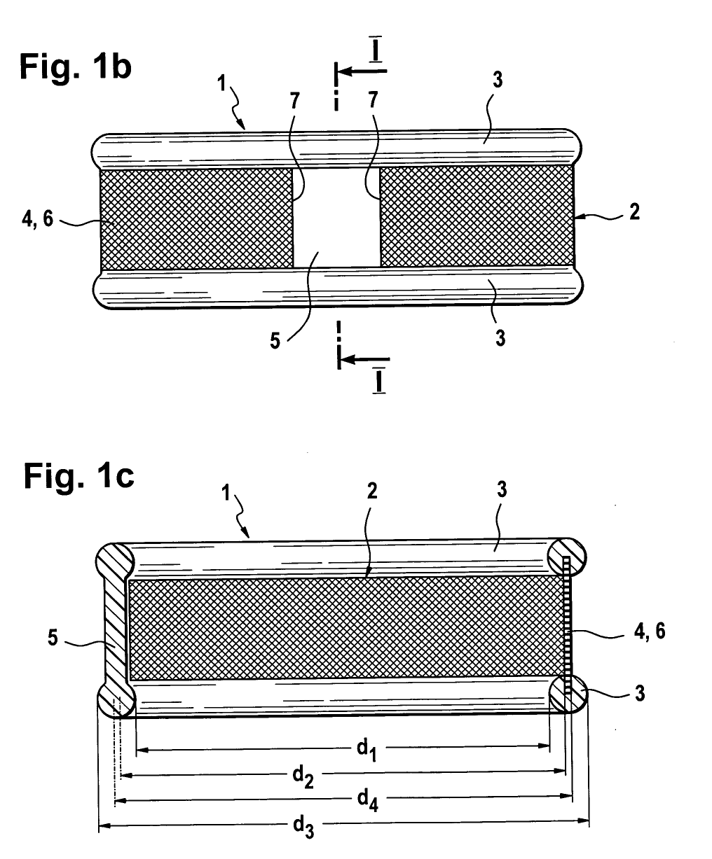

In FIGS. 1a to 1c, a ring filter 1 according to the invention is shown. It comprises a filter section 2 and two frame elements 3. The filter section 2 is formed of a first and a second segment 4, 5. The first segment 4 is provided as a rectangular filter screen 6, with the filter screen 6 being bent into a circular-arc shape and the ends 7 open in the peripheral direction facing each other. The open ends 7 are connected to each other by means of the second segment 5, whereby the filter section 2 obtains the shape of a cylindrical surface. The second segment 5 is formed of an expandable material and is impermeable to hydraulic fluid. In an advantageous embodiment of the invention, the second segment 5 is formed of an elastomer. The connection between the first segment 4 and the second segment 5 is produced, for example, such that the elastomer penetrates the filter screen 6 in a certain region.

The end sides of the filter section 2 in the axial direction are each provided with a frame element 3. Each frame element 3 extends along the entire periphery of an end of the filter section 2. The frame elements 3 have the task, among other things, of ensuring the cylindrical shape of the filter section 2 over a long time. The frame elements 3 are formed of an expandable material, preferably the same as the second segment 5, and they are preferably formed integrally with the second segment 5.

FIG. 1c shows a longitudinal section through the ring filter 1 according to the invention along the line I-I of FIG. 1b. It can be clearly seen that the inner diameter d1 of the frame elements 3 is smaller than the inner diameter d2 of the filter section 2. Likewise, the outer diameter d3 of the frame elements 3 is greater than the outer diameter d4 of the filter section 2.

The first segment 4 of the filter section 2 is connected rigidly to the frame elements 3. Similar to the connection between the first and the second segment 4, 5, it is also provided in this connection that the expandable material of the frame elements 3 penetrates regions of the filter screen 6.

The function of the ring filter 1 shall be explained in the following using the example of a directional valve (control valve 8) for controlling a device 9 for changing the control timing of an internal-combustion engine.

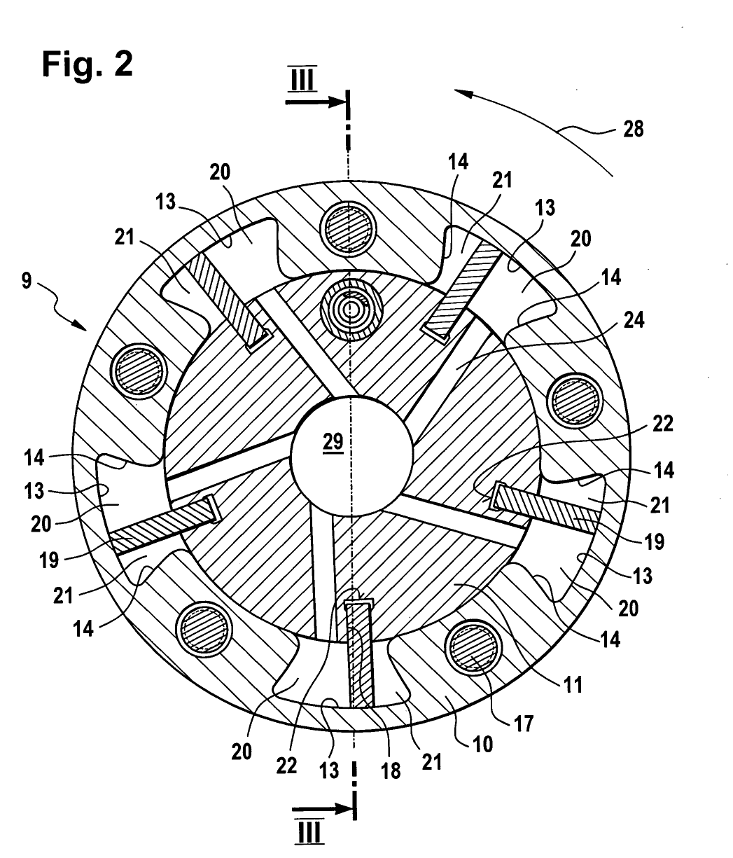

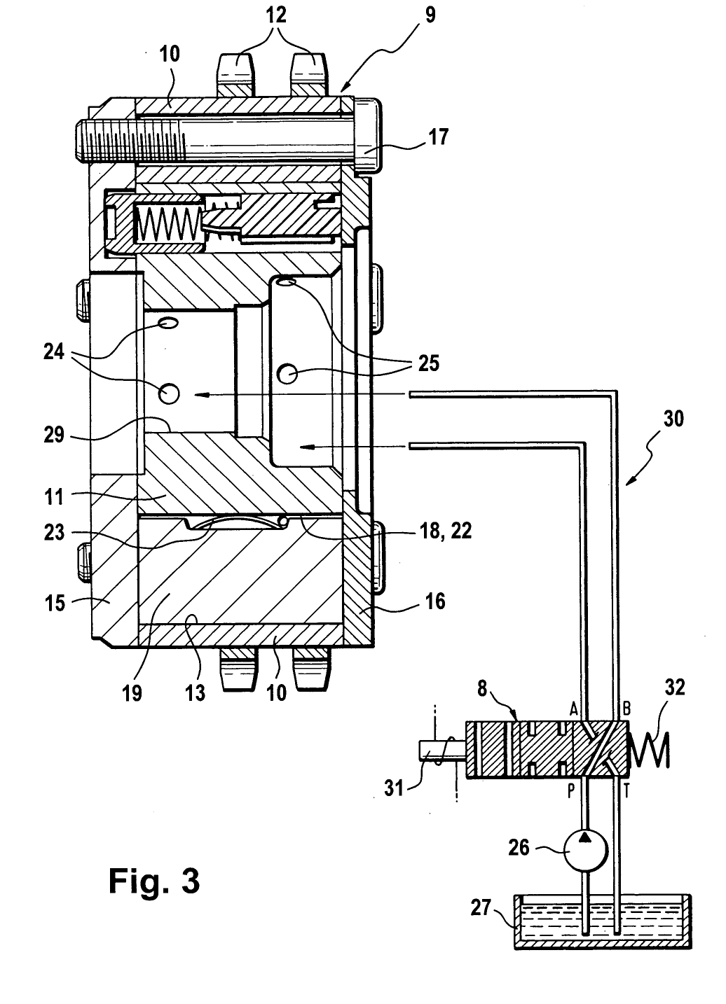

FIGS. 2 and 3 show a device 9 for changing the control timing of an internal-combustion engine. The device 9 essentially comprises a stator 10 and a rotor 11 arranged concentric to the stator. A driving wheel 12 is connected to the stator 10 in a rotationally fixed manner and is provided as a chain wheel in the illustrated embodiment. The stator 10 is supported so that it can rotate on the rotor 11, with five recesses 13 spaced apart in the peripheral direction being provided on the inner surface of the stator 10 in the illustrated embodiment. The recesses 13 are bounded in the radial direction by the stator 10 and the rotor 11, in the peripheral direction by two side walls 14 of the stator 10, and in the axial direction by a first and a second side cover 15, 16. In this way, each of the recesses 13 is closed in a pressure-tight manner. The first and the second side covers 15, 16 are connected to the stator 10 by connecting elements 17, for example, screws.

Axial vane grooves 18 are formed on the outer surface of the rotor 11, with a vane 19 extending in the radial direction being arranged in each vane groove 18. A vane 19 extends into each recess 13, with the vanes 19 contacting the stator 10 in the radial direction and the side covers 15, 16 in the axial direction. Each vane 19 divides a recess 13 into two compression chambers 20, 21 which can work against each other. In order to guarantee pressure-tight contact of the vane 19 on the stator 10, between the groove bases 22 of the vane grooves 18 and the vanes 19, leaf-spring elements 23 are attached, which apply a force to the vane 19 in the radial direction.

By means of first and second compressed-fluid lines 24, 25, the first and second compression chambers 20, 21 can be connected via a control valve 8 to a hydraulic fluid pump 26 or to a tank 27. Therefore, an actuator is formed, which enables relative rotation of the stator 10 relative to the rotor 11. Here, either all of the first compression chambers 20 are connected to the hydraulic fluid pump 26 and all of the second compression chambers 21 are connected to the tank 27 or the exactly opposite configuration. If the first compression chambers 20 are connected to the hydraulic fluid pump 26 and the second compression chambers 21 are connected to the tank 27, then the first compression chambers 20 expand at the cost of the second compression chambers 21. From this a shift of the vane 19 in the peripheral direction results, in the direction illustrated by the arrow 28. By shifting the vane 19, the rotor 11 rotates relative to the stator 10.

In the illustrated embodiment, the stator 10 is driven by a chain drive (not shown) of the crankshaft attaching to its driving wheel 12. The drive of the stator 10 by a belt or gear drive is also conceivable. The rotor 11 is connected to a not-shown camshaft with a positive-fit, non-positive fit, or form fit, for example, by an interference fit or through a screw connection via a central screw. From the relative rotation of the rotor 11 relative to the stator 10, as a result of the supply or discharge of hydraulic fluid to or from the compression chambers 20, 21, a phase shift is produced between the camshaft and the crankshaft. Through selective supply and discharge of hydraulic fluid into the compression chambers 20, 21, the control timing of the gas-exchange valves of the internal-combustion engine can be varied selectively.

The compressed-fluid lines 24, 25 are provided in the illustrated embodiment as essentially radial bores, which extend from a central bore 29 of the rotor 11 to its outer surface. A not-shown central valve, through which the compression chambers 20, 21 can be connected selectively to the hydraulic fluid pump 26 or to the tank 27, is arranged within the central bore 29. Another possibility includes arranging a compressed fluid distributor, which connects the compressed-fluid lines 24, 25 via compressed fluid channels and ring grooves to the connections of an externally attached control valve 8, within the central bore 29.

In FIG. 3, the hydraulic circuit 30 is also shown. A hydraulic fluid connection P of a control valve 8 is provided with hydraulic fluid by a hydraulic fluid pump 26 from a tank 27. Simultaneously, hydraulic fluid is led from the control valve 8 into the tank 27 via a tank connection T. Furthermore, the control valve 8 has two working connections A, B. By means of an electromagnetic actuator 31, which acts against the spring force of a first spring element 32, the control valve 8 can be brought into three positions. In a first position of the control valve 8, which corresponds to a non-powered state of the actuator 31, the working connection A is connected to the tank connection T and the hydraulic fluid connection P is connected to the working connection B and thus to the second compression chamber 21. In a middle position, both the working connection A and also the working connection B are separated from the hydraulic fluid connection P and also from the tank connection T. In a third position of the control valve 8, the hydraulic fluid connection P is connected to the working connection A and consequently to the first compression chamber 20, while the second compression chamber 21 is connected to the tank connection T via the working connection B.

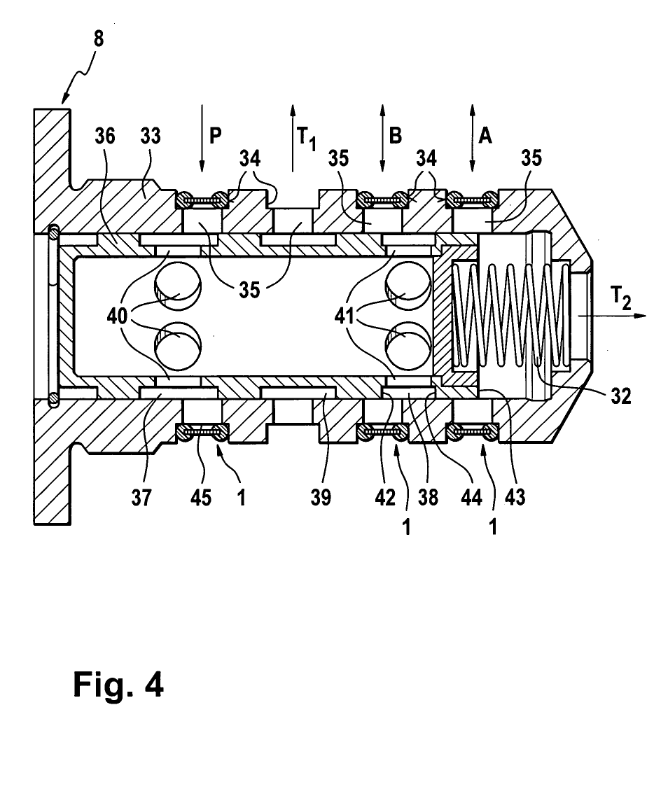

In FIG. 4, a control valve 8 is shown in a longitudinal section. The essentially hollow cylindrical valve housing 33 is provided with a radial hydraulic fluid connection P, a radial tank connection T₁, two working connections A, B, and an axial tank connection T₂. The radial connections P, T₁, A, B are formed as first ring grooves 34 spaced apart from each other in the axial direction. These ring grooves are formed in the outer surface of the valve housing 33. The first ring grooves 34 are provided with several first openings 35, which open into the interior of the valve housing 33.

Within the valve housing 33, a similar essentially hollow cylindrical control piston 36 is arranged so that it can move in the axial direction. By means of a not-shown actuator 31, the control piston 36 can be brought into and held in an arbitrary position within two extreme positions against the spring force of the first spring element 32.

The outer surface of the control piston 36 is provided with a second, a third, and a fourth ring groove 37, 38, 39. The second and the third ring groove 37, 38 communicate via second and third openings 40, 41 with the interior of the control piston 36. The second ring groove 37 is formed such that it communicates with the first openings 35 of the first ring groove 34 of the hydraulic fluid connection P in each position of the control piston 36 relative to the valve housing 33.

During the operation of the internal-combustion engine, hydraulic fluid is led from the hydraulic fluid connection P via the second ring groove 37 and the second openings 40 into the interior of the control piston 36. In the first position of the control piston 36 shown in FIG. 4, the hydraulic fluid is led via the third openings 41 and the third ring groove 36 to the working connection B. By charging the second compression chambers 21 via the working connection B with hydraulic fluid, hydraulic fluid is forced from the second compression chambers 20 to the working connection A and is led via its first openings 35 to the axial tank connection T₂.

If the electromagnetic actuator 31 is powered, then the control piston 36 is pushed against the spring force of the first spring element 32. As a result, the overlapping of the first openings 35 of the working connection B by a first control edge 42 of the third ring groove 38 increases. In the same way, the overlapping of the first openings 35 of the working connection A by a second control edge 43 of the control piston 36 increases. If the control piston 36 reaches a not-shown center position, then the working connection A is no longer connection to the axial tank connection T₂ due to total overlapping of the second control edge 43. Furthermore, neither the working connection A nor the working connection B communicate with the third ring groove 38.

Alternatively, the control piston 36 can be formed, such that both working connections A, B communicate with the third ring groove 38 in the middle position.

If the control piston 36 is pushed further against the spring force of the first spring element 32, then a third control edge 44 frees the first openings 35 of the working connection A to the third ring groove 38. Hydraulic fluid flowing from the hydraulic fluid connection P is now led only to the working connection A. Simultaneously, the fourth ring groove 39 communicates both with the working connection B and also with the radial tank connection T₁. In this way, hydraulic fluid is led from the hydraulic fluid pump 26 into the first compression chambers 20, which leads to relative rotation of the rotor 11 relative to the stator 10. The hydraulic fluid forced from the second compression chambers 21 is led to the radial tank connection T₁ via the working connection B and the fourth ring groove 39.

A ring filter 1 according to the invention is arranged within each of the first ring grooves 34. The frame elements 3 are formed, such that they come into tight contact on the outer surface of the groove base of the first ring groove 34 in the non-expanded state. During the assembly, the second segment 5 of the ring filter 1 expands in the peripheral direction, whereby the inner diameter d2 of the filter section 2 increases. Simultaneously, the inner diameter d1 of the expandable frame elements 3 also increases. The ring filter 1 can now by pushed over the control valve 8 and positioned in the region of a first ring groove 34. In the positioned state, the application of force on the second segment 5 is stopped, whereby the ring filter 1 reassumes its original form and the frame elements 3 come into contact with a positive fit in a sealing manner on the groove base of one of the first ring grooves 34. Hydraulic fluid, which is output from first openings 35 formed in the groove base of the first ring grooves 34, is prevented from flowing past the filter section 2 in the axial direction by the positive-fit connection of the frame elements 3 with the groove base and thus can escape only via the first filter screen 6 of the filter section 2. Through the different sizes of the inner diameter d1, d2 or the outer diameters d3, d4, a filter groove 45 is formed between the groove bases and the filter sections 2 or the filter sections 2 and the adjacent machine part. Now hydraulic fluid flowing from one of the first openings 35 or a connection into one of the filter grooves 45 can be distributed along the entire periphery of the filter section 2, whereby the active filter surface area of the ring filter 1 is increased considerably.

In addition to the embodiment of the ring filter 1 as a cylindrical component, naturally variants are also conceivable, in which the cross section of the ring filter 1 has the shape of an arbitrarily closed curve, such as, for example, an ellipse, or an n-corner form or a polygon. The filter screen 6 can be formed of metal or a plastic or can be configured as a screen plate. Furthermore it is conceivable that the filter screen 6 likewise is formed of an expandable material, preferably the same elastomer as the second segment 5 and the frame elements 3. In this embodiment, the filter screen 2 can be configured completely without a second segment 5 impermeable to hydraulic fluid. An embodiment of a ring filter 1, whose filter section 2 comprises several non-expandable first segments 4, which are connected by means of several second expandable segments 5, is also conceivable.

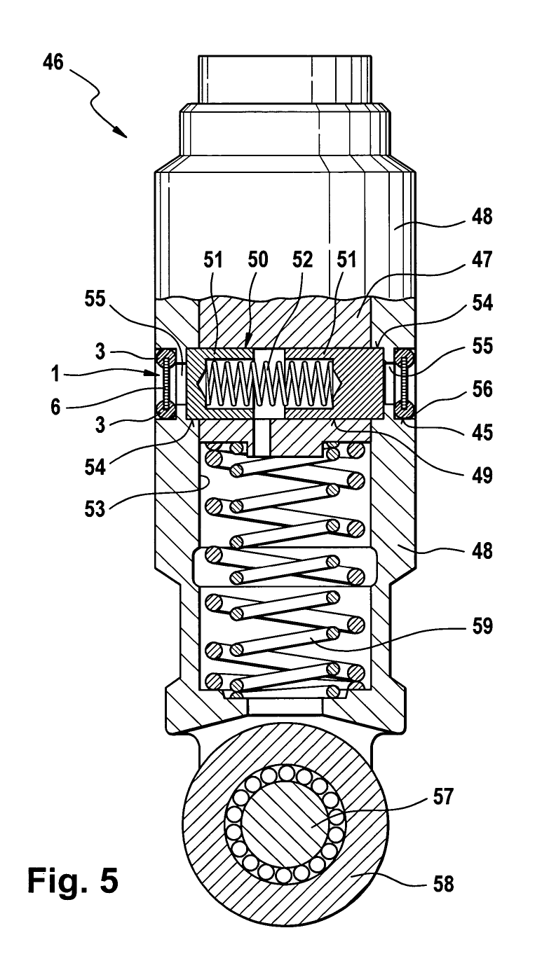

FIG. 5 shows another possible application of the ring filter 1 according to the invention. In the figure, a switchable roller tappet 46 of a not-shown valve drive of an internal-combustion engine is shown, which can be operated in two different switch states. Here, the use of the ring filter 1 according to the invention is not limited to roller tappet 46. Instead, the roller tappet 46 stands for all switching elements of a switchable valve drive, such as, for example, cup tappets, support elements, and the like. The roller tappet 46 comprises an inner and an outer piston 47, 48, wherein the outer piston 48 is hollow. The inner piston 47 is arranged so that it can move in the axial direction within the outer piston 48. A coupling element 50 is arranged within a radial bore 49 of the inner piston 47. The coupling element 50 comprises two pot-shaped coupling pistons 51, whose open sides face each other. A second spring element 52 applies a force forcing the coupling pistons 51 from the radial bore 49 to the coupling pistons 51. Two recesses 54 are formed in the inner surface 53 of the outer piston 48, such that the coupling pistons 51 can be forced by means of the spring force of the second spring element 52 into this element. Each recess 54 is provided with a radial bore 55, which opens into a ring groove 56, which is formed in the outer surface of the outer piston 48. In the shown state, the coupling pistons 51 are forced into the recess 54 and thus the outer pistons are coupled with the inner pistons 48, 47.

During the operation of the internal-combustion engine, a not-shown cam rolls on a cam roller 58 supported with rollers on a pin 57. The pin 57 is connected rigidly to the outer piston 48, whereby during the rolling of the cam on the cam roller 58, the outer piston 48 is moved in its axial direction. In the shown state of the roller tappet 46 (outer piston 48 coupled with the inner piston 47 via the coupling element 50), the axial motion is transferred to the inner piston 47, which drives a not-shown tappet push rod. For decoupling the inner piston 47 from the outer piston 48, the end surfaces of the coupling pistons 51 are charged with hydraulic fluid via the ring groove 56 and the radial bores 55. Therefore, the coupling pistons 51 are forced into the radial bore 49 and the outer piston 48 can oscillate freely relative to the inner piston 47 in its axial direction. Between the outer piston 47 and the inner piston 48, a third spring element 59 is arranged, which forces the outer piston 48 to the cam in the uncoupled state of the roller tappet 46.

The dimensions of the coupling piston 51 are fitted to the dimensions of the inner surface of the radial bore 49. Contaminating particles, which penetrate into the radial bores 55 via the ring groove 56, can be led into the intermediate space between the coupling piston 51 and the inner surface of the radial bore 49 and can cause jamming of the coupling piston 51. To prevent this, a ring filter 1 according to the invention is inserted within the ring groove 56.

The ring filter 1 according to the invention is suitable for use in all hydraulic systems, in which hydraulic fluid is transferred from one machine part to another via a ring groove. For example, directional control valves, switchable cam followers, play-compensating elements, rotary transmission leadthroughs, for example, from a camshaft bearing into the camshaft, and the like, can be mentioned here.

### REFERENCE SYMBOLS

1 Ring filter
2 Filter section
3 Frame element
4 First segment
5 Second segment
6 Filter screen
7 End
8 Control valve
9 Device
10 Stator
11 Rotor
12 Driving wheel
13 Recess
14 Side wall
15 First side cover
16 Second side cover
17 Connecting element
18 Vane groove
19 Vane
20 First compression chamber
21 Second compression chamber
22 Groove base
23 Leaf-spring element
24 First compressed-fluid line
25 Second compressed-fluid line
26 Hydraulic fluid pump
27 Tank
28 Arrow
29 Central bore
30 Hydraulic fluid circuit
31 Actuator
32 First spring element
33 Valve housing
34 First ring groove
35 First opening
36 Control piston
37 Second ring groove
38 Third ring groove
39 Fourth ring groove
40 Second opening
41 Third opening
42 First control edge
43 Second control edge
44 Third control edge
45 Filter groove
46 Roller tappet
47 Inner piston
48 Outer piston
49 Radial bore
50 Coupling element
51 Coupling piston
52 Second spring element
53 Inner surface
54 Recess
55 Bore
56 Ring groove
57 Pin
58 Cam roller
59 Third spring element
d1 Inner diameter
d2 Inner diameter
d3 Outer diameter
d4 Outer diameter
P Hydraulic fluid connection
T Tank connection
T₁ Radial tank connection
T₂ Axial tank connection
A First working connection
B Second working connection

1. Ring filter (1) for filtration of hydraulic fluid, comprising
a filter section (2),
which has essentially the shape of a cylindrical surface, wherein
the ring filter (1) is circumferentially closed to itself and is reversibly expandable.

2. Ring filter (1) according to claim 1, wherein
the filter section (2) is formed as a filter screen (6) made form an expandable material.

3. Ring filter (1) according to claim 1, wherein
the filter section (2) comprises at least one first and one second segment (4, 5),
the segments are arranged alternately in a peripheral direction,
wherein the second segment (5) is impermeable to hydraulic fluid and comprises an expandable material and
the first segment (4) is formed as a non-expandable filter screen (6).

4. Ring filter (1) according to claim 3, wherein the filter screen (6) is formed of metal.

5. Ring filter (1) according to claim 3, wherein the filter screen (6) is formed of plastic.

6. Ring filter (1) according to claim 1, wherein
on each end side of the filter section (2) in an axial direction there is a ring-shaped frame element (3),
the frame element is connected to the filter section (2) along its entire periphery
and is formed of an expandable material.

7. Ring filter (1) according to claim 1, wherein the ring filter (1) is arranged within a first ring groove (34) of a control valve (8) of a camshaft adjuster, the first ring groove (34) is formed in an outer surface of a valve housing (33) of the control valve (8) and is used as a connection for compressed fluid.

8. Ring filter (1) according to claim 1, wherein the ring filter (1) is arranged within a ring groove (56) of a hydraulic switching element of a switchable valve drive, the ring groove (56) is formed in an outer surface of the switching element of the valve drive and is used as a compressed fluid connection.
